(19) United States
(12) Patent Application Publication
(10) Pub. No.: US 2003/0120632 A1
(43) Pub. Date: Jun. 26, 2003

(54) System and method for retrieving and processing electronically posted medical provider payments

(76) Inventors: Paul Casey, Boston, MA (US); James Munz, Watertown, MA (US); Kevin J. Foley, Boston, MA (US)

Correspondence Address: LAHIVE & COCKFIELD, 28 STATE STREET, BOSTON, MA, 02109, US

(21) Appl. No.: 10/285,983

(22) Filed: Nov. 1, 2002

(30) Foreign Application Priority Data
Dec. 22, 2001 (JP) 2001-83500

(51) Int. Cl. G06F 7/00

(52) U.S. Cl. 707/1

(57) ABSTRACT

A method of programmatically retrieving and processing electronically posted medical bill payments is disclosed. Electronically posted payment information is programmatically retrieved, parsed into a pre-determined format and stored in a permanent database. The information is subsequently retrieved from the database/storage location and reformatted to meet individual medical provider requirements compatible with the medical provider's internal billing systems. The retrieved payment information is used to update the billing records for previously submitted claims from the medical provider. Data is parsed into transaction level, claim level and service level information. Information on denials of payment and partial payments for submitting claims is stored in the permanent database and later utilized to generate Explanation of Benefit report needed to re-submit the medical claims to the same or different medical carrier.

### FIELD OF THE INVENTION

The illustrative embodiment of the present invention relates generally to medical payment posting and more particularly to the retrieval and processing of electronically posted medical payment information.

### BACKGROUND

Medical bills are usually generated as the result of treatment, equipment or medicine received by a patient from a medical provider. The medical provider, such as a hospital or doctor's office, submits a claim to the insurer, HMO or other contractually obligated party (hereafter the “carrier”) seeking payment for the services rendered. Each claim may include more than one itemized service. For example, a claim may include a first service fee for a physical examination and a second service fee for an x-ray. The insurer carrier pays for the services within the claim based on its contractual obligations with the medical provider. The payments may be pre-determined amounts for specific procedures or pre-determined percentages of the amount submitted. Alternatively, the payment amount may be determined by the carrier on a case-by-case basis. The amount or percentage paid may differ for services within a single claim.

The electronic method frequently chosen by carriers for the dispersal of medical payment information is an electronic payment posted to a designated posting location, such as a computer bulletin board. The medical payment information may be electronic records of payments claim payments or may be authorization codes and information necessary to engage in an electronic payment. The medical payment information is posted as transactions which are identified by provider claim and service. The medical provider retrieves the information from the electronic bulletin board, processes the information and updates their billing records accordingly.

There are a number of drawbacks with the conventional manner of retrieving payment information from the posting location. The payment information may be in a data format not recognized by the medical provider's computer system. Additionally, the medical provider may have to manually request the information and then manually post the information to their patient billing records. Where scripting techniques are used to programmatically post payments, the scripting techniques often lack error-checking capability, and often process the information without any sort of long-term storage of the payment information. The lack of long-term storage of the payment information is particularly significant in those cases where either a denial or a partial payment has been made by the carrier. The denial or partial payment often leads to a second submittal of the claim, either a re-submittal of the claim to the original carrier, or an original submittal of the claim to a second carrier which is obligated to pay for rejected first claims. This is frequently the case in Medicare situations where Medigap coverage is applicable. The second claim often requires information to be included which indicates how the first claim was handled.

### SUMMARY OF THE INVENTION

The illustrative embodiment of the present invention provides a method of retrieving and processing payment information posted by a carrier. Posted payment information is programmatically retrieved and saved in a predetermined format in long-term storage. The medical payment information may then be retrieved from the long-term storage and converted into a provider's specific data format as required. The retrieved information is programmatically parsed into specific claim and service level groupings and used to update the medical provider's patient billing records. The illustrative embodiment of the present invention provides a method of error checking during the posting process to ensure data reliability. Additionally, the storage of medical payment information includes denial and partial payment information which may be utilized to generate explanation of benefit statements required for re-submission of a claim to an original carrier or to a secondary carrier.

In one embodiment of the present invention, a posting location which is accessible over a network holds electronic payment information posted by a medical carrier. Also interfaced with the network is an electronic device operated by a medical provider holding patient billing records. Medical carriers post electronic payment information to the posting location where it is programmatically retrieved using a posting application. The posting application executes from a network-accessible location. The retrieved payment information is parsed into a predetermined format and stored in a network accessible location. In one aspect of the invention, the stored parsed payment information is programmatically converted into a format requested by a medical provider and used to update the billing records of the medical provider.

In another embodiment, a medical payment processing system includes a posting application. The posting application is a software application used to retrieve and parse electronically posted medical payment information stored at a posting location. The information is retrieved over a network. The medical payment processing system also includes a storage location holding patient billing information for a medical provider. Also included in the medical payment processing system is a storage location holding parsed medical payment information, the parsed medical payment information being stored and parsed by the posting application.

### BRIEF DESCRIPTION OF THE DRAWINGS

FIG. 1 depicts an environment suitable for practicing the illustrative embodiment of the present information;

FIG. 2 is a flowchart of the sequence of steps followed by the illustrative embodiment of the present invention to retrieve medical payment information and post the retrieved information to a medical provider's billing records;

FIG. 3 depicts the sequence of steps followed by the illustrative embodiment of the present invention to identify payment denials and generate denial reports; and

FIG. 4 is a flowchart of the sequence of steps followed by the illustrative embodiment of the present invention to generate an explanation of benefits statement and re-submit a claim for previously denied services.

### DETAILED DESCRIPTION

The illustrative embodiment of the present invention provides a method of programmatically retrieving and processing electronically posted medical bill payments. Electronically posted payment information is programmatically retrieved, parsed into a pre-determined format and stored in a permanent database. The information is subsequently retrieved from the database/storage location and reformatted to meet individual medical provider requirements compatible with the medical provider's internal billing systems. The retrieved payment information is used to update the billing records for previously submitted claims from the medical provider. Data is parsed into transaction level, claim level and service level information. Information on denials of payment and partial payments for submitting claims is stored in the permanent database and later referenced to generate explanation of benefit forms required for resubmitting the medical claims to the same or different medical carrier.

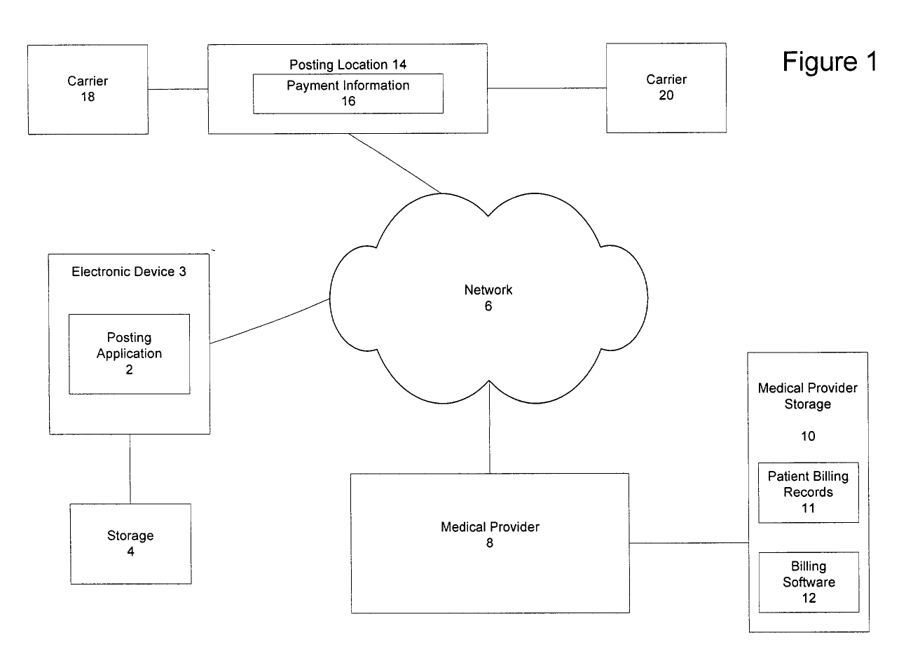

FIG. 1 depicts a block diagram of an environment suitable for practicing the illustrative embodiment of the present invention. A posting application 2 executes from an electronic device 3 having access to a network 6. The network may be the Internet, a wide area network (WAN), a satellite network, or some other type of network. The posting application 2 also has access to storage 4. The storage 4 may be a database or some other type of storage. The storage 4 is used by the illustrative embodiment of the present invention to generate reports required for resubmitting previously denied claims and to analyze the posting process as set forth in more detail below. The posting application 2 is used to retrieve posted medical payment information 16 from a posting location 14. The posting location may be an electronic bulletin board or other pre-designated location accessible over the network 6, such as a web site with restricted access. The medical payment information 16 includes transaction information identifying the medical provider, claim information identifying the patient, and service information identifying the individual services within the patient's claim. The medical payment information 16 indicates who the payment is directed to, what the payment is for, and how much of the payment is being made. It may also include an indication that the payment is being made via a physical check, may indicate the particulars of a wire transaction, or may allow a medical provider to dynamically transfer funds in real-time. The payment information 16 is posted to the posting location 14 by a plurality of medical carriers 18 and 20. The medical carriers are insurance companies or other guarantors contractually obligated to make payment for certain covered medical. The payment information 16 relates to medical claims submitted by a medical provider 8 for services provided to patients. The medical provider 8 has access to its own internal medical provider storage 10 holding the patient billing records 11 for the provider's patients and may operate its own internal billing software 12. Those skilled in the art will recognize that the posting application 2 may be operated from the location of the medical provider 8 instead of executing from a remote location on the network 6. Alternatively, the posting application 2 may work in conjunction with the billing software 12 of the medical provider to update the patient billing records 11 instead of accessing the patient billing records directly.

The medical carriers 18 and 20 electronically post the payment information 16 using a carrier-specific data format. The information is posted using one of several text delimited formats where the information is grouped into fields. Depending upon which format is being used, the same information may appear in different fields. The posting application 2 retrieves the payment information by inserting the information into a template appropriate for the format. The information is then converted from the carrier format into the X12 format or some other pre-determined data format, and stored in the storage 4. This method of retrieval allows for error checking as missing fields are easily identifiable. The retrieval process may be scheduled in advance and performed programmatically. Those skilled in the art will recognize that the payment information 16 may already be in the desired format at the time it is posted by the medical carriers 18 and 20, in which case the conversion process is skipped and the data is checked for errors and stored.

Once stored, the payment information 16 may be used to update the patient billing records 11 for a medical provider 8. The posting application 2 establishes a connection with the medical provider 8, and determines the format used by the medical provider. The posting application 2 converts the stored payment information into the provider-specific format from the storage format by using a template to place the stored information into the proper fields in the provider format. In one aspect of the invention, the posting application is already aware of the data format used by the medical provider 8 prior to establishing the connection. In another aspect of the invention, the data format used by the medical provider 8 is determined dynamically following the establishment of the connection. Any missing information is quickly identified (since fields in the template used to update the provider billing records 11 will be empty) and error reports are generated for incomplete data. Claims which have missing payment information 16 are not updated by the posting application 2, but are updated later following a review of the error report and the missing information. Claims for which all of the required fields are complete in the template are sent to update the patient billing records 11. In one embodiment, the posting application 2 updates the patient billing records 11 in the medical provider storage 10 directly. In an alternate embodiment, the posting application 2 provides the payment information 16 to the medical provider's billing software 12 which uses the information to update patient billing records 11. Similarly to the retrieval process, the posting of the payment information 16 to the patient billing records 11 may be scheduled to execute automatically at specified times.

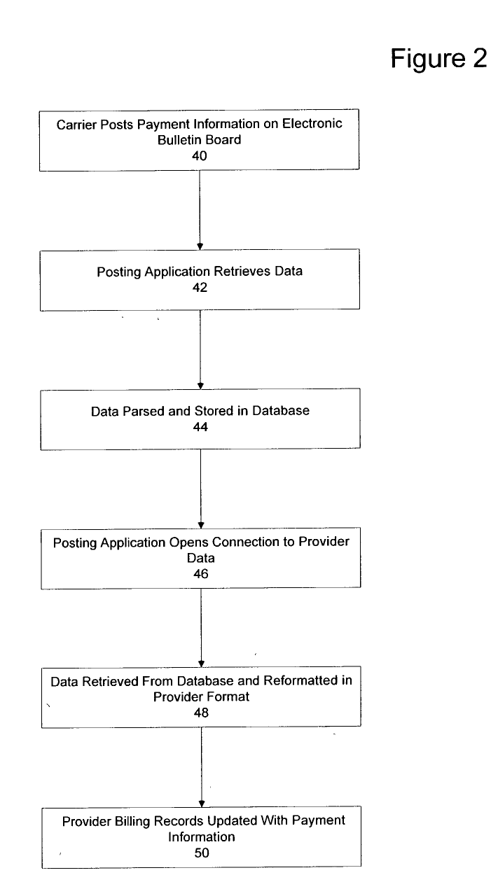

FIG. 2 is a flowchart of the sequence of steps followed by illustrative embodiment of the present invention to programmatically retrieve posted medical payment information 16 from a posting location 14 and use the information to update medical patient billing records 11. The sequence begins when a carrier 18 and 20 posts medical payment information 16 on an electronic bulletin board or other posting location 14 (step 40). The payment information may be data confirming an already completed transaction or may be information such as account information and authorization codes necessary to conduct a future transaction. The posting application 2 then retrieves the data from the posting location 14 (step 42). The data is parsed and stored in storage 4 in a pre-determined format such as the X12 format (step 44). The data is parsed into transaction level, claim level and service level groupings. The posting application 2 then opens a connection to the medical provider 8 and accesses the patient billing records 11 (step 46). Data is retrieved from storage 4 by the posting application 2, converted from the stored format (such as the X12 format) into a format designated by the medical provider 8 (step 48). The medical data is then used to update the patient billing records 11 in the medical providers storage 10 (step 50). The updating may be done in conjunction with billing software 12 executing within the medical providers computer system.

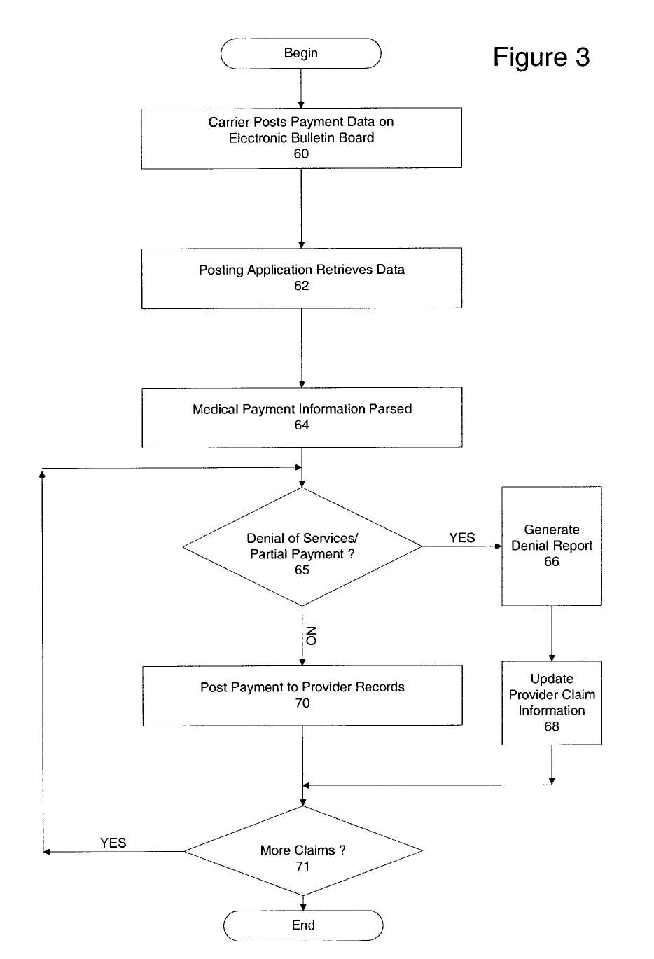

Medical carriers do not pay every claim submitted by a provider. FIG. 3 depicts the sequence of steps followed by the illustrative embodiment of the present invention to handle payment denial and/or partial payments by a medical carrier. The sequence begins when the medical carrier 18 and 20 posts payment data onto a posting location such as an electronic bulletin board (step 60). The posting application 2 retrieves the payment information 16 from the posting location 14 (step 62). The retrieved payment information is then parsed into a pre-determined format such as the X12 format (step 64). The parsed data is examined to determine whether the medical carrier denied payment for services in submitted claims, either in whole or in part (step 65). If a determination is made that the medical carrier has denied services either in whole or in part, the posting application generates a denial report listing the retrieved information (step 66) and then updates the patient billing records 11 (step 68). Alternatively, if the determination is reached that the medical carrier has not denied services either in whole or in part for submitted claims, the parsed payment information is used to update the medical patient billing records directly (step 70) without generating a denial report. Following the updating of the medical patient billing records, the retrieved payment information is examined to determine whether it includes additional claims from the medical provider (step 71). If the retrieved payment information does include additional claims, the process iterates and the next claim is examined to determine whether it includes any denied services and/or partial payments (step 65).

The storage of medical payment information 16 in storage 4 allows the illustrative embodiment of the present invention to generate reports which may be used by a medical provider 8 to increase the efficiency of its claim processing. The stored medical payment information 16 may be mined to generate a number of different types of reports, including but not limited to exception reports and refund reports. Exception reports flag claims that have already been paid by another carrier for later review. Similarly, refund reports mark claims that have been paid by more than one carrier and require a refund to the carrier. Exceptions and refund situations are detected by the posting application 2 upon updating the patient billing records.

The illustrative embodiment of the present invention additionally enables the creation of “allowance” reports. Allowance reports form part of a practice management system and enable a provider to determine how much a carrier is actually paying for services versus what the carrier is claiming to pay. Additional reports generated using the medical payment information 16 include a credit balance report which displays all credit balances created when inputting the payment information into the practice management system, and a print claims report which displays which claims were requested by the application to be printed out for submission to secondary insurance. The medical payment information 16 is also used to create a “Cycle of Service” report which displays a breakdown of message codes sent from the insurer to the medical practice for items which were denied and associates them with a task in the billing management process. The billing management process between the time of receipt of the medical payment information by the medical provider 8 and the resubmitting of claims is discussed further below. Those skilled in the art will recognize that the medical payment information may be leveraged to produce a number of different types of reports in addition to those listed herein without departing from the scope of the present invention.

The illustrative embodiment of the present invention allows the medical payment information 16 to be examined prior to being put into storage. Tasks related to the submitted claims are put into a job queue by the medical provider prior to the placement of the medical payment information into storage. Tasks may include email reminders to check the status of the claim in 30 days and to resubmit the bill if the bill has not been paid. Tasks may relate to the creation and examination of Explanation of Benefit reports. Different staff members may be assigned to contact the patient with follow up questions. Efficiency experts may examine patterns in the paid claims with automated help from the posting application 2 and the provider billing software 12. The various tasks are pre-determined by the provider and the posting application 2 is used to programmatically establish the job queue. At the end of a pre-determined time period the bills may be resubmitted accompanied by required documentation.

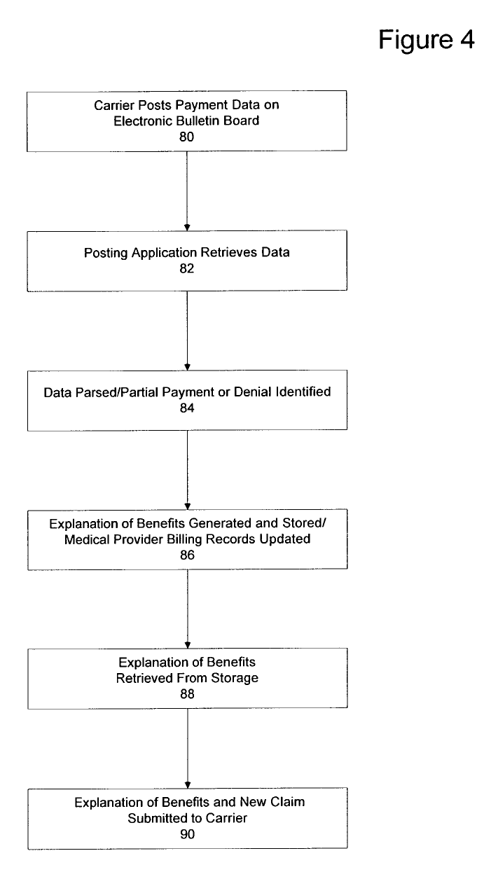

FIG. 4 is a flowchart depicting the sequence of steps followed by the illustrative embodiment of the present invention to generate an explanation of benefits statement for use in re-submitting previously denied claims. Explanation of Benefits reports are often required by medical carriers to accompany the submittal/re-submittal of a previously submitted claim. The sequence begins when one or more medical carriers 18 and 20 post medical payment information 16 to an electronic bulletin board (step 80). The posting application 2 retrieves the medical payment information 16 from the posting location 14 (step 82). The data is parsed by the posting application 2 and any partial payments or denial of services are identified by the posting application 2 (step 84). An explanation of benefits is generated and stored in storage 4 by the posting application 2. The medical provider 8 billing records located in the medical provider storage 10, are then updated using the parsed data (step 86). Subsequently, the explanation of benefits statements is retrieved from storage 4 (step 88) and attached to a new claim being submitted to the secondary carrier or re-submitted to the original carrier (step 90).

The illustrative embodiment of the present invention also allows for the real-time processing of medical claims. The posting application 2 may interact dynamically with the medical provider 8 and the medical carrier 18 or 20 to provide rapid determinations as to how much of a claim is being paid by a medical carrier. The provider may provide services to a patient and submit the claims immediately while the patient is still on-site or a short period of time later such as the same day. The posting application may then check a pre-determined location for medical payment information for electronic payment information posted by the carrier in response to the claim submission. The provider may then optionally collect any unpaid balance from the patient. Those skilled in the art will recognize that real-time processing or rapid processing of claims requires both the provider and the carrier to configure the appropriate software to respond within a pre-determined time frame.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. In a network with at least one posting location, and an electronic device operated by a medical provider, a method comprising the steps of:
programmatically retrieving posted medical payment information from said posting location using a posting application, said posting application accessible over said network,
parsing the retrieved payment information into a pre-determined format; and
storing said parsed payment information in storage accessible over said network.

2. The method of claim 1, comprising the further steps of:
programmatically converting the stored parsed payment information into a format requested by said medical provider; and
updating a patient billing record of said medical provider using said payment information.

3. The method of claim 2, comprising the further step of:
using a billing software application executed by the medical provider in combination with said payment information in order to update the billing records of said medical provider.

4. The method of claim 1 comprising the further steps of:
parsing said payment information into at least one of separate transaction groupings, claims groupings, and service groupings, said transaction groupings identified by medical provider, said claims groupings identified by patient, and said service groupings identified by services contained within a claim.

5. The method of claim 1 wherein said payment information is parsed into the X12 format.

6. The method of claim 1, comprising the further step of:
storing said posting application and a billing software application on said electronic device operated by said medical provider.

7. The method of claim 1, comprising the further steps of:
determining as a result of said parsing of said medical payment information that payment for a service was at least partially denied; and
storing information about said denial and said service in said storage location.

8. The method of claim 7, comprising the further steps of:
retrieving programmatically the information about said denial and said service from said storage location; and
using said information about said denial and said service to submit a new request for payment.

9. The method of claim 8 wherein said information about said denial and said service is used to generate an Explanation of Benefits form, said Explanation of Benefits form accompanying said request for payment.

10. The method of claim 1 wherein said posting location is an electronic bulletin board.

11. The method of claim 1, comprising the further steps of:
examining programmatically said medical payment information;
creating tasks relating to the examined medical payment information, said tasks being further actions by the medical provider related to said medical payment information; and
placing said tasks in a job queue accessible to said medical provider.

12. The method of claim 11, comprising the further steps of:
retrieving a task from said job queue; and
performing an action specified in said task.

13. A medical payment processing system, comprising:
a posting application, said posting application being a software application used to retrieve over a network and parse electronically posted medical payment information from a posting location holding said medical payment information;
a medical provider storage medium holding medical billing information for a medical provider; and
a storage medium holding parsed medical payment information, said parsed medical payment information being stored by said posting application.

14. The system of claim 13 wherein the parsed medical payment information includes at least one of separate transaction groupings, claims groupings, and service groupings, said transaction groupings identified by medical provider, said claims groupings identified by patient, and said service groupings identified by services contained within a claim.

15. In a network with at least one posting location, and an electronic device operated by a medical provider, a method comprising the steps of:
programmatically retrieving posted medical payment information from said posting location using a posting application, said posting application accessible over said network,
parsing the retrieved medical payment information into a pre-determined format;
determining as the result of said parsing that said medical payment information includes at least a partial denial of claimed services;
storing said parsed medical payment information in storage accessible over said network;
programmatically converting the stored parsed medical payment information into a format requested by said medical provider; and
updating the billing records of said medical provider using said medical payment information.

16. In a network with at least one posting location, said posting location being a location accessible over said network which holds medical carrier electronic payment information, and an electronic device operated by a medical provider, a medium holding computer-executable steps for a method, said method comprising the steps of:
programmatically retrieving medical payment information from a posting location using a posting application, said posting application accessible over said network;
parsing the retrieved payment information into a pre-determined format; and
storing said parsed payment information in storage accessible over said network.

17. The medium of claim 16, wherein said method comprises the further steps of:
programmatically converting the stored parsed payment information into a format requested by said medical provider; and
updating the billing records of said medical provider using said payment information.

18. The medium of claim 16 wherein said method comprises the further step of:
using a billing software application executed by the medical provider in combination with said payment information in order to update the billing records of said medical provider.

19. The medium of claim 16 wherein said method comprises the further steps of:
determining as a result of said parsing of said medical payment information that payment for a service was at least partially denied;
creating an Explanation of Benefits report, said Explanation of Benefits report indicating the reasons for said at least partial denial; and
storing information about said at least partially denied service and said Explanation of Benefits report in said storage.

20. The medium of claim 19 wherein said method comprises the further steps of:
retrieving programmatically the information about said denial and said service from said storage; and
using said information about said at least partial denial of service to submit a new request for payment.

21. The medium of claim 20 wherein said new request is accompanied by said Explanation of Benefits report.
